(19) United States
(12) Patent Application Publication
(10) Pub. No.: US 2026/0178521 A1
(43) Pub. Date: Jun. 25, 2026

(54) COMMUNICATION CONTROL DEVICE FOR A SUBSCRIBER STATION OF A SERIAL BUS SYSTEM AND METHOD FOR HANDLING MESSAGES IN A SUBSCRIBER STATION OF A SERIAL BUS SYSTEM

(71) Applicant: Robert Bosch GmbH, Stuttgart (DE)

(72) Inventors: Arthur Mutter, Neuhausen (DE); Florian Hartwich, Reutlingen (DE); Suresh Anju, Bengaluru(Koramangala) (IN); Vignesha Pavanje, Bengaluru(Koramangala) (IN)

(21) Appl. No.: 19/404,707

(22) Filed: Dec. 1, 2025

(30) Foreign Application Priority Data
Dec. 20, 2024 (DE) 10 2024 139 318.1

(51) Int. Cl. G06F 13/18

(52) U.S. Cl. CPC G06F 13/18

(57) ABSTRACT

A communication control device for a subscriber station for a serial bus system and a method for handling messages in a subscriber station of a serial bus system. The communication control device has a message management module for managing messages to be transmitted by the communication control device onto a bus for controlling communication of the subscriber station with at least one other subscriber station, a transmission order determination module for determining a sequence index for the messages, wherein each message has an identifier which indicates the priority with which the message is to be transmitted onto the bus, wherein the transmission order determination module is designed to determine a sequence index for each identifier and to assign it to the identifier, and wherein the message management module is designed to ascertain the transmission order for messages whose identifiers have the same value, using the sequence index.

### CROSS REFERENCE

The present application claims the benefit under 35 U.S.C. § 119 of Germany Patent Application No. DE 10 2024 139 318.1 filed on Dec. 20, 2024, which is expressly incorporated herein by reference in its entirety.

### FIELD

The present invention relates to a communication control device for a subscriber station of a serial bus system and to a method for handling messages in a subscriber station of a serial bus system that operates with a high data rate and high error robustness.

### BACKGROUND INFORMATION

A bus system is often used for communication between sensors and control units of technical systems, for example in vehicles. In the bus system, data are created, transmitted and read as messages. There are many different standards for this purpose, for example Classical CAN or CAN FD or CAN XL, which are each standardized in the international standard ISO 11898-1:2024. The messages are transmitted between the bus subscribers of the bus system, such as sensors, control devices, encoders, etc. The bus subscribers are also called nodes or subscriber stations.

Each subscriber station of a bus system has a transmission memory in which more than one message can be stored. A communication controller manages the messages in the transmission memory and determines the order in which these messages are transmitted, according to different criteria. In time-controlled systems, such as FlexRay or TTCAN, there is a system-wide definition of when which message is to be transmitted. Often, the transmission memories are managed in such a way that the messages are transmitted in the order in which they are written to the memory. Such a transmission order is also known as FIFO order (FIFO=FIRST IN FIRST OUT).

In contrast, the transmission order of messages of a subscriber station in CAN bus systems is usually ascertained by internal arbitration in the subscriber station. CAN identifiers are used here. Each message that is stored in the transmission memory of the subscriber station and that is to be transmitted via the bus is assigned a CAN identifier. The message whose CAN identifier has the highest priority according to the rules of CAN bus arbitration is transmitted onto the bus first. Such a transmission order is also known as a priority queue.

The problem, however, is that this internal queuing procedure in CAN does not provide a clear result if the subscriber station is to transmit two or more messages with the same CAN identifier. It is possible that the relative transmission order of such messages with the same CAN identifier depends on the positions of these messages in the transmission memory of the subscriber station. This is the case, for example, with an M CAN IP module from the applicant of the present patent application, which module is currently available on the market. However, it is also possible that the relative transmission order of such messages with the same CAN identifier is random.

However, if the specified transmission order is not maintained, this may result in the messages being unusable and having to be transmitted again. This reduces the effective net data rate in the bus system. As a result, the time specifications of the higher-level technical system cannot be met.

### SUMMARY

It is an object of the present invention to provide a communication control device for a subscriber station of a serial bus system, and a method for handling messages in a subscriber station of a serial bus system, which solve the aforementioned problems. In particular, a communication control device for a subscriber station of a serial bus system and a method for handling messages in a subscriber station of a serial bus system are to be provided, in which a high data rate on the bus and a high error robustness of the communication can be realized.

The object may be achieved by a communication control device for a subscriber station of a serial bus system having certain features of the present invention. According to an example embodiment of the present invention, the communication control device has a message management module for managing messages that are to be transmitted by the communication control device onto a bus of the bus system for controlling communication of the subscriber station with at least one other subscriber station of the bus system, a transmission order determination module for determining a sequence index for the messages, wherein each message has an identifier, the value of which indicates the priority with which the message is to be transmitted onto the bus, wherein the transmission order determination module is designed to determine a sequence index for each identifier and to assign it to the identifier, and wherein the message management module is designed to ascertain the transmission order for messages whose identifiers have the same value, using the sequence index.

Due to the design of the communication control device, the specified transmission order for messages is maintained. For this purpose, the communication control device specifies a transmission order for a sequence of messages with the same CAN identifier. However, the communication control device does not need to control memory positions of these messages with the same CAN identifier. In addition, the communication control device does not need to use a FIFO memory for this purpose.

Consequently, the method that can be performed by the communication control device can be implemented with very little resource expenditure since the sequence index only needs to have a small value range and also allows a jump back to 0.

Another advantage is that the communication control device does not have to take the positions of messages in the memory into account when it enters a sequence of messages with the same CAN identifier into a transmission memory managed as a “priority queue.” Instead, the communication control device can use all free memory locations in the memory.

This means that the specified transmission order for messages can be maintained with little expenditure of time and at little cost.

Another major advantage is that the internal arbitration of an existing communication control device only needs to be adapted slightly. The adaptation can be easily inserted into any communication control device, in particular CAN controller. This means that communication control devices already in use, in particular CAN controllers, can be retrofitted very easily. This saves resources.

Therefore, the communication control device allows for the different CAN bus systems to be used for certain applications in technical systems, in particular in vehicles, which require as mandatory a unique transmission order of messages of a subscriber station with the same CAN identifier. Such applications include, for example, fragmentation according to CiA613-3, CANsec according to CiA613-2, or ISO-TP according to the international standard ISO 15765-2.

The design of the communication control device of the present invention described above contributes to ensuring that no malfunctions occur in the higher-level system(s), since the correct order of messages is maintained according to the intended priority, and a net data rate of at least 5 Mbit/s up to approximately 8 Mbit/s or 10 Mbit/s or higher, in particular up to 20 Mbit/s, can also be realized on the bus. In this case, one bit is less than 100 ns long. In addition, the size of the payload data can be up to 2048 bytes per frame. Of course, a variety of values for the number of bytes per frame is possible, in particular up to 512 bytes or 1024 bytes or any other value.

Advantageous further embodiments of the communication control device are disclosed herein.

According to an example embodiment of the present invention, the transmission order determination module may be designed to assign the determined sequence index in a message storage module to the identifier, wherein the message management module is designed to ascertain the transmission order for messages whose identifiers have the same value, using the sequence index stored in the message storage module. Here, the message storage module may comprise a transmit priority queue having a predetermined number of memory slots, in which a message with the identifier and the sequence index is stored.

In one example embodiment of the present invention, the message storage module has a transmit priority queue having a predetermined number of memory slots, in which a message is stored with the identifier, the sequence index, and a range, wherein the sequence index has a predetermined value range, and wherein the range is one of three ranges into which the predetermined value range of the sequence index is divided.

The sequence index can be an integer selected from the predetermined value range, wherein the transmission order determination module is designed to increment the sequence index for each consecutive message in the transmit priority queue and, after exceeding the maximum value of the predetermined value range of the sequence index, to jump back to the minimum value of the value range for the next message in the transmit priority queue.

According to one exemplary embodiment of the present invention, the predetermined value range of the sequence index is determined in that there is a difference of at least 3×#Slt−4 between the minimum value of the sequence index and the maximum value of the sequence index, where #Slt is the predetermined number of memory slots in the transmit priority queue.

It is possible that the predetermined value range of the sequence index is divided into three directly consecutive ranges, which have a first, second and third range and each have a minimum size of #Slt−1, where #Slt is the predetermined number of memory slots in the transmit priority queue, wherein the first range starts with the minimum value of the sequence index, wherein the second range is arranged in a seamless and non-overlapping manner between the first range and the third range, and wherein the third range ends with the maximum value of the sequence index.

The communication control device of the present invention described above can be part of a subscriber station for a serial bus system, which subscriber station also has a transmitting/receiving device for transmitting a signal generated by the communication control device for a frame, onto a bus of the bus system and for receiving a signal from the bus, wherein the communication control device is designed to negotiate with the other subscriber stations on the bus in the first communication phase which of the subscriber stations of the bus system will at least temporarily receive exclusive, collision-free access to the bus in the subsequent second communication phase.

According to an example embodiment of the present invention, optionally, the transmitting/receiving device is designed to generate bus states for the frame with a first operating mode in a first communication phase and to generate bus states for the frame with a second operating mode that differs from the first operating mode, in a second communication phase.

The subscriber station of the present invention described above can be part of a bus system which additionally comprises a bus and at least two subscriber stations which are connected to one another via the bus in such a way that they can communicate serially with one another. At least one of the at least two subscriber stations is an above-described subscriber station.

The object mentioned above is also achieved by a method for handling messages in a subscriber station of a serial bus system of the present invention. According to an example embodiment of the present invention, the method is carried out with a communication control device of the subscriber station, wherein the communication control device carries out the steps of: managing, with a message management module, messages that are to be transmitted by the communication control device onto a bus of the bus system for controlling communication of the subscriber station with at least one other subscriber station of the bus system; determining, with a transmission order determination module, a sequence index for the messages, wherein each message has an identifier whose value indicates the priority with which the message is to be transmitted onto the bus, wherein the transmission order determination module determines, in the step of determining, a sequence index for each identifier and assigns it to the identifier, and
wherein the message management module, in the step of managing, ascertains the transmission order for messages whose identifiers have the same value, using the sequence index.

The method of the present invention provides the same advantages as mentioned above in relation to the message handling device and/or the subscriber station.

Further possible implementations of the present invention also include combinations, even those not explicitly mentioned, of features or embodiments described above or below with respect to the exemplary embodiments. In this case, a person skilled in the art will also add individual aspects as improvements or additions to the relevant basic form of the present invention, in view of the disclosure herein.

### BRIEF DESCRIPTION OF THE DRAWINGS

The present invention is described in more detail below with reference to the figures and based on exemplary embodiments.

FIG. 1 shows a simplified block diagram of a bus system according to a first exemplary embodiment of the present invention.

FIG. 2 shows a diagram illustrating the structure of a message that can be transmitted and/or received by a subscriber station of the bus system according to the first exemplary embodiment of the present invention.

FIG. 3 shows a simplified schematic block diagram of a subscriber station of the bus system according to the first exemplary embodiment of the present invention.

FIG. 4 and FIG. 5 show a time profile of signals that occur during normal operation in the bus system according to the first exemplary embodiment of the present invention.

FIG. 6 shows a diagram of a structure of a part of a communication control device of the subscriber station of FIG. 3.

FIG. 7 shows a diagram illustrating a function of a message management module of the communication control device of FIG. 6.

In the figures, identical or functionally identical elements are given the same reference signs unless otherwise indicated.

### DETAILED DESCRIPTION OF EXAMPLE EMBODIMENTS

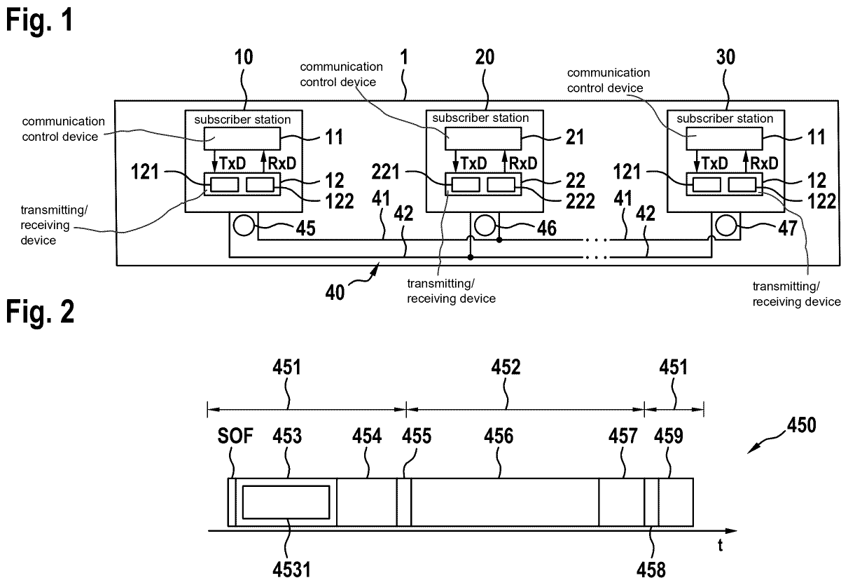

FIG. 1 shows as an example a bus system 1, which can, in particular, at least in portions, be a CAN bus system, a CAN FD bus system, a CAN XL bus system, etc. The bus system 1 can be used in a vehicle, in particular a motor vehicle, an aircraft, etc., or in a hospital, etc.

In FIG. 1, the bus system 1 has a plurality of subscriber stations 10, 20, 30, which are each connected to a bus 40 or bus line having a first bus wire 41 and a second bus wire 42. The bus wires 41, 42 can also be called CAN_H and CAN_L for the signals on the bus 40. Messages 45, 46, 47 in the form of signals are transmitted between the individual subscriber stations 10, 20, 30 via the bus 40. The subscriber stations 10, 20, 30 are, for example, control units or display devices of a motor vehicle.

As shown in FIG. 1, the subscriber stations 10, 30 each have a communication control device 11 and a transmitting/receiving device 12. The transmitting/receiving device 12 has a transmitting module 121 and a receiving module 122.

The subscriber station 20 has a communication control device 21 and a transmitting/receiving device 22. The transmitting/receiving device 22 has a transmitting module 221 and a receiving module 222.

The transmitting/receiving devices 12 of the subscriber stations 10, 30 and the transmitting/receiving device 22 of the subscriber station 20 are each directly connected to the bus 40, even though this is not shown in FIG. 1.

The communication control devices 11, 21 are each used for controlling communication of the corresponding subscriber station 10, 20, 30 via the bus 40 with at least one other subscriber station of the subscriber stations 10, 20, 30 which are connected to the bus 40.

The communication control device 11 creates and reads first messages 45, 47, which are, for example, CAN messages 45, 47. Here, the CAN messages 45, 47 are constructed, for example, on the basis of the CAN XL format according to ISO 11898-1:2024. The transmitting/receiving device 12 serves for transmitting and receiving the messages 45, 47 from the bus 40. The transmitting module 121 receives a digital transmit signal TxD generated by the communication control device 11 for one of the messages 45, 47 and converts said transmit signal into signals on the bus 40. The digital transmit signal TxD can be a pulse-width-modulated signal, at least temporarily or in sections. The receiving module 122 receives signals transmitted on the bus 40, corresponding to the messages 45 to 47, and generates a digital receive signal RxD therefrom. The receiving module 122 transmits the receive signal RxD to the communication control device 11.

In addition, the communication control device 11 can be designed to create and read second messages 46, which are, for example, CAN FD messages 46. The transmitting/receiving device 12 can be designed accordingly.

The communication control device 21 can be designed like a conventional CAN controller according to ISO 11898-1:2024, i.e., like a CAN FD-tolerant Classical CAN controller or a CAN FD controller. The communication control device 21 creates and reads second messages 46, for example CAN FD messages. The transmitting/receiving device 22 is used to transmit and receive the messages 46 to/from the bus 40. The transmitting module 221 receives a digital transmit signal TxD generated by the communication control device 21 and converts said transmit signal into signals for a message 46 on the bus 40. The receiving module 222 receives signals transmitted on the bus 40, corresponding to the messages 45 to 47, and generates a digital receive signal RxD therefrom. The transmitting/receiving device 22 may be designed like a conventional CAN FD transceiver or CAN SIC transceiver.

With the two subscriber stations 10, 30, a formation and then transmission of messages 45, 47 with different CAN formats, in particular the CAN FD format or the CAN XL format, as well as the reception of such messages 45, 47, can be realized. This is described in more detail below for a message 45.

FIG. 2 shows, for the message 45, a frame 450, which is in particular a CAN XL frame or a CAN FD frame, as provided by the communication control device 11 for the transmitting/receiving device 12 for transmitting onto the bus 40. In this case, the communication control device 11 creates the frame 450 as compatible with CAN FD in the present exemplary embodiment. Alternatively, the frame 450 is compatible with any successor standard for CAN FD or CAN XL.

According to FIG. 2, the frame 450 is divided, for CAN communication on the bus 40, into different communication phases 451, 452, namely, an arbitration phase 451 (first communication phase) and a data phase 452 (second communication phase). After a start bit SOF, the frame 450 has an arbitration field 453, a control field 454, a first switching field 455, a data field 456, a checksum field 457, a second switching field 458 and a frame termination field 459. The checksum field 457, the second switching field 458 and the frame termination field 459 form a frame end phase 457, 458, 459 of the frame 450. The arbitration field 453 is used to store an identifier 4531. A Classical CAN frame does not have switching fields 455, 458.

In the arbitration phase 451, with the aid of the identifier (ID) 4531 in the arbitration field 453, negotiation takes place bitwise between the subscriber stations 10, 20, 30 as to which subscriber station 10, 20, 30 wishes to transmit the message 45, 46 with the highest priority and will therefore receive exclusive access to the bus 40 of the bus system 1 for the near future for transmitting in the subsequent data phase 452. A physical layer such as in CAN and CAN FD is also used in CAN XL in the arbitration phase 451. The physical layer corresponds to the bit transmission layer or layer 1 of the conventional OSI model (Open Systems Interconnection Model).

During the phase 451, the conventional CSMA/CR method is used, which allows simultaneous access of the subscriber stations 10, 20, 30 to the bus 40 without the higher-priority message 45, 46 being destroyed. As a result, further bus subscriber stations 10, 20, 30 can be added relatively easily to the bus system 1, which is very advantageous.

The CSMA/CR method has the consequence that there must be so-called recessive states on the bus 40 (FIG. 1), which can be overwritten by other subscriber stations 10, 20, 30 with dominant levels or dominant states on the bus 40. In the recessive state, high-impedance conditions prevail at the individual subscriber station 10, 20, 30, which in combination with the parasites on the bus circuit results in longer time constants. This leads to a limitation of the maximum bit rate of the present-day CAN-FD physical layer at currently about 2 megabits per second in real vehicle use.

At the end of the arbitration phase 451 of CAN FD and CAN XL, the first switching field 455 is used to switch to the data phase 452.

In the data phase 452, in addition to a portion of the first switching field 455, the payload data of the CAN XL frame 450 or of the message 45 from the data field 456 are transmitted, and so is the checksum field 457 and a portion of the second switching field 458. With today's CAN-XL physical layer, a maximum bit rate of up to about 20 megabits per second is possible in the data phase 452. At the end of the data phase 452 of CAN FD and CAN XL, the second switching field 458 is used to switch back to the arbitration phase 451.

A transmitter of the message 45 begins to transmit bits of the data phase 452 onto the bus 40 only when the subscriber station 10 as the transmitter has won the arbitration and the subscriber station 10 as the transmitter thus has exclusive access to the bus 40 of the bus system 1 for transmitting.

Thus, in the arbitration phase 451 as the first communication phase, the subscriber stations 10, 30 use, in part, in particular up to the FDF bit (inclusive) according to ISO 11898-1:2024, a format from CAN/CAN FD, according to ISO 11898-1:2024. However, in comparison with CAN or CAN FD, an increase in the net data transmission rate, in particular to over 10 megabits per second, is possible in CAN XL in the data phase 452 as the second communication phase. In addition, an increase in the size of the payload data per frame, in particular to about 2 kilobytes or any other value, is possible.

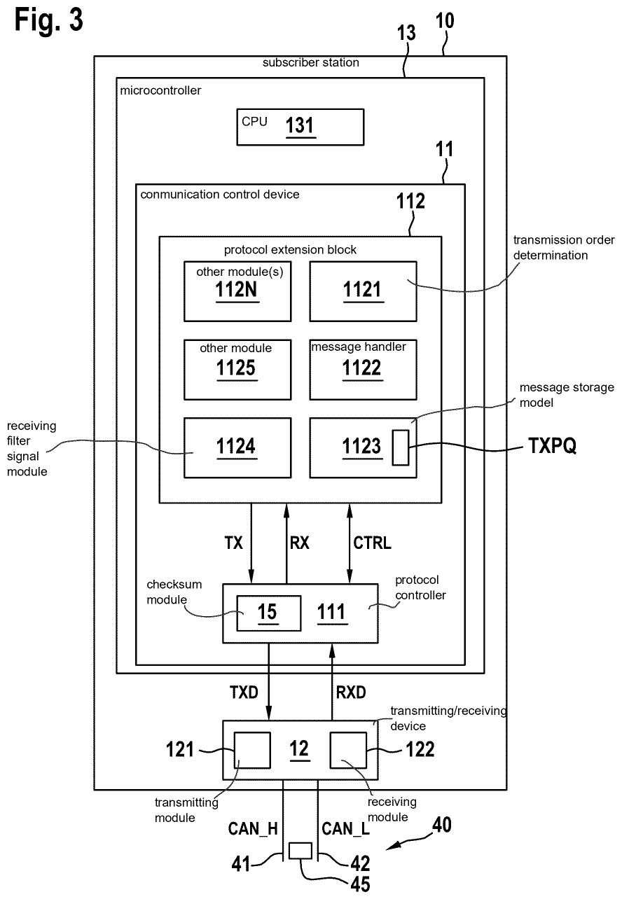

FIG. 3 shows the basic structure of the subscriber station 10 with the communication control device 11 and the transmitting/receiving device 12. The subscriber station 30 and/or the subscriber station 20 can be constructed in a similar manner as shown in FIG. 3. For this reason, the subscriber stations 20, 30 are not described separately.

According to FIG. 3, the subscriber station 10 has, in addition to the communication control device 11 and the transmitting/receiving device 12, a microcontroller 13 to which the communication control device 11 is assigned and that comprises a central processing unit (CPU) 131. Additional parts of the subscriber station 10, such as a power supply device which supplies the transmitting/receiving device 12 with electrical energy, are not shown in FIG. 3 for simplicity.

The communication control device 11 is basically designed for the implementation of the CAN functions according to ISO 11898-1:2024.

The communication control device 11 has a protocol controller 111 and a protocol extension block 112. The protocol controller 111 creates a frame 450 (FIG. 2) for a message 45 on the bus 40 from a message of the microcontroller 13. The protocol extension block 112 provides at least one additional function that is not carried out by the protocol controller 111.

In the protocol controller 111, modules are provided that create and process the messages 45 according to ISO 11898-1:2024. In particular, a checksum module 15 and/or at least one additional module can be provided for this purpose. The checksum module 15 calculates at least one checksum for the frame 450 of the message 45.

The protocol extension block 112 has at least one extension module 1121 but has in particular a plurality of extension modules 1121 to 112N. In the example of FIG. 3, the block 112 has a transmission order determination module 1121, a message management module 1122 (message handler), a message storage module 1223 with a transmit priority queue TXPQ (TXPQ=transmit priority queue), a receive signal filter module 1124, and optionally other modules 1125 to 112N. Any number of modules or other modules can be provided and used.

The protocol extension block 112 contains all higher-order protocol extension functions. The functions can be modular, i.e., implemented by the individual modules 1121 to 112N. The protocol extensions or protocol extension functions can thus be easily added and have no effect on the protocol controller 111. In principle, the protocol extensions can be implemented alternatively or additionally in software. The software is then executed on the central processing unit 131 of the microcontroller 13. At least one signal CRTL, with which the transmitting and receiving can be controlled, can be exchanged between the protocol controller 111 and the protocol extension block 112.

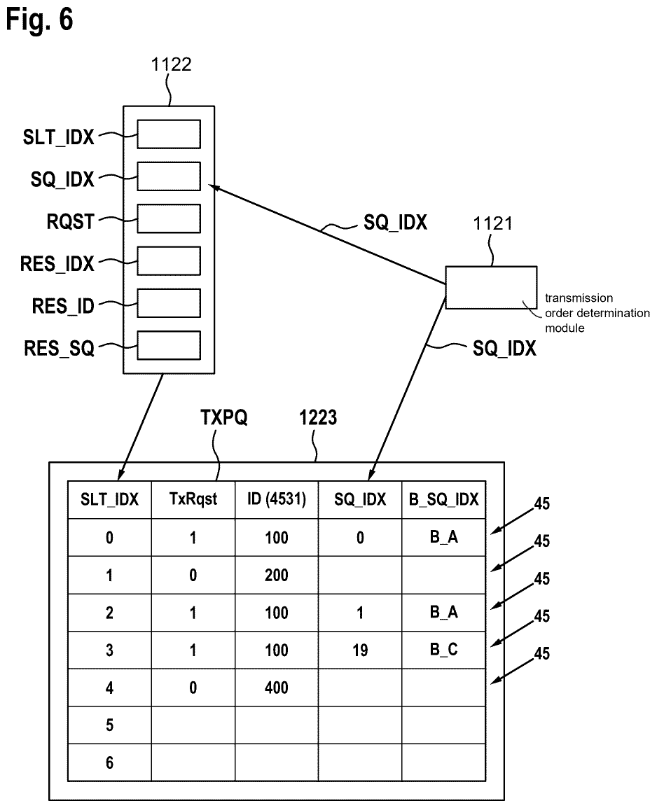

The transmission order determination module 1121 is designed to additionally assign a predetermined variable SQ_IDX to the individual messages 45 that are created by the protocol controller 111 and have the same priority ID or identifier 4531 (ID for arbitration on the bus 40). As explained in more detail with reference to FIG. 6, the predetermined variable SQ_IDX is stored, with the message 45 to be transmitted, in the message storage module 1223, more precisely the transmit priority queue TXPQ (TXPQ=transmit priority queue). The predetermined variable SQ_IDX is used for internal arbitration in the subscriber station 10, as described in more detail below. The transmission order determination module 1121 can be implemented in software.

The message management module 1122 (message handler) of FIG. 3 is designed to manage a predetermined number of messages 45 to be transmitted and a predetermined number of received messages 45 in the message storage module 1223. The necessary memory in which the messages 45 to be transmitted or already received are stored can additionally or alternatively be arranged outside the communication control device 11. Here, status information, for example as to whether a message 45 is stored, is stored in the message management module 1122.

If necessary, the message management module 1122 can transmit messages 45 divided into multiple smaller frames 450 and can receive messages 45 divided into multiple smaller frames 450. Thus, the message management module 1122 can assign the parts of a message 45 to the message 45.

The message storage module 1223 has predetermined storage elements, which are designed to store messages 45 or to store at least a part of a message 45, and which are designed to store additional information about the messages 45, in particular a variable SQ_IDX. This is described in more detail with reference to FIG. 6.

The receive signal filter module 1124 of FIG. 3 can filter incoming messages 45 in order to relieve the central processing unit 131.

The transmitting/receiving device 12 has the transmitting module 121 and the receiving module 122. Although reference is always made to the transmitting/receiving device 12 below, it is alternatively possible to provide the receiving module 122 in a separate device externally from the transmitting module 121. The transmitting module 121 and the receiving module 122 can be constructed as in a conventional transmitting/receiving device 22.

The transmitting/receiving device 12 is connected to the bus 40, put more precisely the first bus wire 41 thereof for CAN_H or CAN-XL H and the second bus wire 42 thereof for CAN_L or CAN-XL_L.

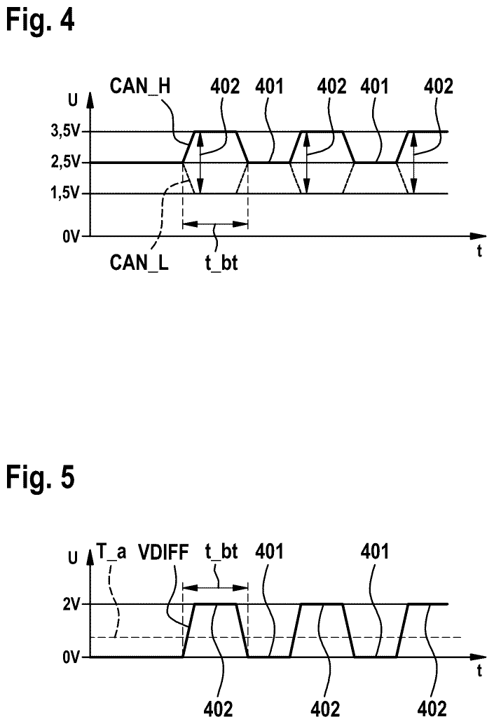

During operation of the bus system 1, the transmitting module 121 of the transmitting/receiving device 12 converts a transmit signal TxD of the communication control device 11 into corresponding signals CAN_H and CAN_L for the bus wires 41, 42 and transmits these signals CAN_H and CAN_L onto the bus 40 at the terminals for CAN_H and CAN_L. An example of the signals CAN_H, CAN_L is shown in FIG. 4. If the transmitting/receiving device 12 uses a voltage supply other than 5 V, the voltage values for the signals CAN_H and CAN_L also change at its terminals for CAN_H and CAN_L.

The transmitting/receiving device 12 implements layer 1 of the conventional OSI model, i.e., the transmitting/receiving device 12 physically encodes the individual bits to be transmitted, on the bus 40. As a result, a differential voltage VDIFF=CAN_H−CAN_L is formed on bus 40. An example of the differential voltage VDIFF resulting from the signals of FIG. 4 is shown in FIG. 5.

The receiving module 122 of the transmitting/receiving device 12 forms a receive signal RxD from the signals CAN_H and CAN_L according to FIG. 4 received from the bus 40, or the differential voltage VDIFF according to FIG. 5, and forwards this receive signal to the communication control device 11, as shown in FIG. 3. With the exception of an idle or standby state, in normal operation, the transmitting/receiving device 12, with the receiving module 122, constantly listens for a transmission of data or messages 45, 46 on the bus 40, regardless of whether or not the transmitting/receiving device 12 is the transmitter of the message 45.

According to the example of FIG. 4, the signals CAN_H and CAN_L have, at least in the arbitration phase 451, the dominant and recessive bus levels or bus states 401, 402, as from CAN. The individual bits of the VDIFF signal with the bit time t_bt can be recognized with a reception threshold of 0.7 V. In the data phase 452, the bits of the signals CAN_H and CAN_L in CAN FD and CAN XL are transmitted faster, i.e., with a shorter bit time t_bt, than in the arbitration phase 451. Thus, the signals CAN_H and CAN_L in the data phase 452 of CAN FD or CAN XL can differ from the conventional signals CAN_H and CAN_L according to Classical CAN at least in their higher bit rate.

The sequence of states 401, 402 for the signals CAN_H, CAN_L in FIG. 4 and the resulting profile of the voltage VDIFF of FIG. 5 serves only to illustrate the function of the subscriber station 10. The sequence of the data states for the bus states 401, 402 can be selected as required.

During operation of the subscriber station 10, the communication control device 11 proceeds as follows to define a transmission order for a group of messages 45 or their frames 450 (FIG. 2) that have the same identifier 4531 (FIG. 2). For this purpose, the communication control device 11 of FIG. 3, in particular its transmission order determination module 1121, defines an internal priority for this group of messages 45 or their frames 450 (FIG. 2), as described in more detail below with reference to FIG. 6. Of course, the same applies to messages 46, 47, even if only message 45 is mentioned below.

The CAN priority of a message 45 or its frame 450 (FIG. 2) is determined by its identifier 4531. The CAN priority is higher if the identifier 4531 has a smaller numerical value. The CAN priority is low(er) if the identifier 4531 has a large or larger numerical value. The identifier 4531 is used for arbitration between subscriber stations 10, 20, 30 on the bus 40, as from ISO 11898-1:2024.

The protocol controller 111 can start transmitting the message 45 or its frame 450 (FIG. 2) onto the bus 40 when the CAN bus is “idle,” i.e., either because no communication is active or because the end of “intermission” of a CAN frame 450 (FIG. 2) or of a message 45 is detected. “Intermission” can also be referred to as interframe spacing and corresponds to the predetermined distance that must be maintained after the end of a frame 450 before the next frame 450 may be transmitted onto the bus 40, i.e., before the next transmit option onto the bus 40 exists. At the latest at the time of this transmit option, the message management module 1122 (message handler) must provide the protocol controller 111 with the message 45 or frame 450 to be transmitted.

The transmission order determination module 1121 can dynamically manage the elements of the transmit priority queue TXPQ. In addition, when the transmission order determination module 1121 wants to write a new message 45 to be transmitted, into an element or memory slot of the transmit priority queue TXPQ, it always receives only a pointer to a free element or memory slot of the transmit priority queue TXPQ from the message management module 1122.

As shown in FIG. 6 as an example, the messages 45 or frames 450 may therefore be in a different order in the transmit priority queue TXPQ than the order in which they are to be transmitted. In FIG. 6, the transmit priority queue TXPQ has seven memory slots SLT_IDX, namely 0 to 6, for messages 45 with their control elements TxRqst, SQ_IDX, B_SQ_IDX.

In the example of FIG. 6, five messages 45 are stored, wherein, for simplicity, only the identifier ID (4531) of the messages 45 is given in detail, in decimal notation. The transmission order determination module 1121 assigns the control elements SQ_IDX. The control elements SQ_IDX yield the control element B_SQ_IDX for a first range B_A, a second range B_B and a third range B_C, as described in more detail below. The ranges B_A, B_B, B_C follow one another in a seamless and non-overlapping manner.

For each element or memory slot SLT_IDX of the transmit priority queue TXPQ, there is a status bit that indicates the transmit request (TxRqst) of the element or message in the memory slot SLT_IDX. The control element TxRqst is a control bit and indicates whether the message 45 stored in the transmit priority queue TXPQ is to be transmitted (TxRqst=1) or whether there is no transmit request for the message 45 stored in the transmit priority queue TXPQ (TxRqst=0). This status bit changes when an element or message 45 in the memory slot SLT_IDX of the transmit priority queue TXPQ has been successfully transmitted, when the transmission order determination module 1121 enters a new message 45 into the transmit priority queue TXPQ, or when a transmission job is canceled. The cancellation of the transmission job can be done, for example, by software of the transmission order determination module 1121 or the microcontroller 13 and is called transmit cancellation. Alternatively, the transmission job can be canceled by hardware, for example because the maximum number of transmission attempts has been reached for this element or message in the memory slot SLT_IDX of the transmit priority queue TXPQ. The transmit cancellation function is optional and is not supported by all message management modules 1122 (message handlers).

The message management module 1122 (message handler) uses the variables SLT_IDX, RQST, RES_IDX, RES_ID, RES_SQ to find out which message 45 of the messages 45 stored in the transmit priority queue TXPQ is to be transmitted next. For this purpose, the transmission order determination module 1121 informs the message management module 1122 of the control element sequence index SQ_ID.

As described in more detail below, the message management module 1122 can store, initially as an intermediate result, the currently highest priority identifier ID (4531) in the variable RES_ID and additionally store the index for the memory slot in which this identifier ID (4531) was found, in the variable RES_IDX. In addition, the message management module 1122 stores the sequence index SQ_IDX found there, in the variable RES_SQ. This intermediate result in the variables RES_ID, RES_IDX, RES_SQ is updated when an identifier ID (4531) that has a higher priority and for which TxRqst=1 applies is seen in a memory slot. After the last transmission slot of the queue TXPQ has been checked, the result is available, which consists of the three values of the variables RES_ID, RES_IDX and RES_SQ. The range B_SQ_IDX results automatically from the value for the sequence index SQ_IDX and does not need to be stored by the message management module 1122.

Each time a value for the TxRqst bit in the transmit priority queue TXPQ changes, the message management module 1122 performs a scan through the elements or memory slots SLT_IDX of the transmit priority queue TXPQ to find the element or message 45 that has the highest transmit priority after the change, in a memory slot SLT_IDX in the transmit priority queue TXPQ. The scan can also be called Tx_Scan.

The transmission order determination module 1121, in cooperation with the message management module 1122, ensures that a high-priority message 45, which has an identifier (ID) 4531 with a low numerical value and that the transmission order determination module 1121 has written into the transmit priority queue TXPQ just before the next transmit option onto the bus 40, can be started at this next transmit option. For this purpose, the modules 1121 and 1122 are designed such that the message management module 1122 (message handler) can quickly recognize this message 45 as the highest-priority message 45 or the frame 450.

This prevents another CAN frame 450 from being started at this transmit option, by the subscriber station 10 or by another subscriber station 10, 20, 30 on the bus 40, so that the highest-priority message has to wait until this other CAN frame 450 ends.

For this purpose, the transmission order determination module 1121 and the message management module 1122 together carry out a two-part method. The first part of the method comprises how the transmission order determination module 1121, for a group of messages 45 with the same identifier 4531, determines the internal order of the messages 45 in the group. The second part of the method comprises how the message management module 1122 finds the next message 45 to be transmitted, in the transmit priority queue TXPQ in a single scan pass (Tx_Scan).

The transmit priority queue TXPQ consists of a group of elements in one memory slot SLT_IDX each, wherein an element stores a message 45 together with additional control information (e.g., the sequence index SQ_IDX).

The message management module 1122 (message handler) manages the elements or memory slots SLT_IDX of the transmit priority queue TXPQ of the message memory 1122 in such a way that the CAN messages 45 stored there are transmitted in the order of their CAN priority (ID) 4531 and the transmission order determined by the transmission order determination module 1121. Here, messages 45 having the same CAN identifier 4531 (FIG. 2) are transmitted relative to one another in an order specified by the message management module 1122. The message management module 1122 can have and use application software for this purpose.

The first part of the method, in particular the transmission order determination module 1121, can be implemented in software as follows.

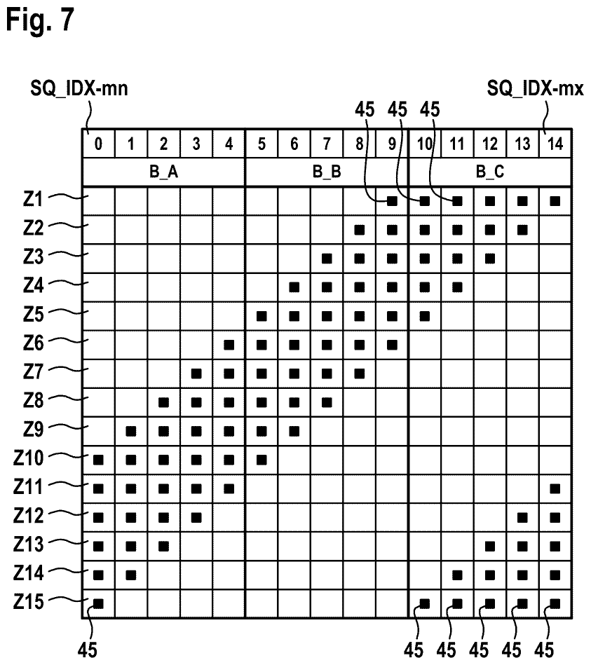

The transmission order determination module 1121 transmits the desired transmission order to the message management module 1122 via the sequence index variable SQ_IDX. The transmission order determination module 1121 writes the variable SQ_IDX together with the message 45 into an element or memory slot SLT_IDX of the transmit priority queue TXPQ, as illustrated by an arrow in FIG. 6. It is often desired that, given a group of messages 45 that have the same identifier 4531, these messages 45 are transmitted in the same order in which they were written into the transmit priority queue TXPQ. In such a case, these messages 45, which have the same identifier 4531, must be written into the transmit priority queue TXPQ with incrementing sequence index SQ_IDX values so that the SQ_IDX values represent the internal transmission order. Examples in this respect are described below with reference to FIG. 7 in connection with the third exemplary embodiment.

According to FIG. 6, the sequence index SQ_IDX is an integer number in a value range from a minimum value SQ_IDX-mn (in particular 0) to a maximum value SQ_IDX-mx (at least SQ_IDX-mn+3×#Slt−4), where #Slt is the maximum number of elements or memory slots SLT_IDX in the transmit priority queue TXPQ. The value range may also be larger. However, a value range that is too large has the disadvantage that a longer variable SQ_IDX has to be managed, which increases the effort required to perform the method. The minimum value SQ_IDX-mn can alternatively have a value other than 0.

In the example of FIG. 6, the transmit priority queue TXPQ has seven elements or memory slots SLT_IDX, so that #Slt=7. The sequence index SQ_IDX can therefore be an integer number in the range of 0 to 19. The range of 0 to 19 means that SQ_IDX-mn has the value 0 and SQ_IDX-mx has the value 19. In this example, the ranges A and C are each 7 elements in size, while the middle range B is only 6 elements in size. The range B is thus smaller than the ranges A and C. The ranges A, B, and C are not all the same size.

In the example of FIG. 6, one of the messages 45 with an identifier 100 has already been transmitted. After that, a message 45 with an identifier 200 was stored in the memory slot.

The transmission order determination module 1121 manages a separate variable SQ_IDX(ID) for each transmission identifier 4351. For this purpose, the module 1121 uses at least one counter, in particular one counter per transmission identifier 4351. Each time the transmission order determination module 1121 writes a message 45 with a predetermined CAN identifier 4531 into the transmit priority queue TXPQ, the module 1121 increments the associated sequence index SQ_IDX(ID), or the corresponding count value of the counter. The incrementation occurs cyclically; the maximum value is followed by 0. That is to say, for the identifier 4531 (100) in FIG. 6, the transmission order determination module 1121 manages a separate variable SQ_IDX(100). In addition, the transmission order determination module 1121 manages a separate variable SQ_IDX(200) for the identifier 4531 (200) in FIG. 6. In addition, the transmission order determination module 1121 manages a separate variable SQ_IDX(300) for the identifier 4531 (300) in FIG. 6. In addition, the transmission order determination module 1121 manages a separate variable SQ_IDX(400) for the identifier 4531 (400) in FIG. 6.

The second part of the method can be implemented in hardware as follows.

The transmit priority queue TXPQ can then contain up to #Slt messages with the same identifier 4531, or value for the identifier 4531, if the transmit priority queue TXPQ only contains messages 45 with the same identifier 4531, or the same value for the identifier 4531. In addition, the values of the sequence index SQ_IDX of the messages 45 are then numbered cyclically in monotonically increasing order, with a possible jump back from the maximum value SQ_IDX-mx to the minimum value SQ_IDX-mn, wherein the minimum value SQ_IDX-mn can in particular have the value 0 or any other value according to the above-mentioned specifications. The values of the sequence index SQ_IDX are also referred to below as SQ_IDX values.

If there is no jump back in the SQ_IDX values in the transmit priority queue TXPQ, the messages 45 are to be transmitted relative to one another in the order of their values for the memory slots of the queue TXPQ of the memory module 1123, i.e., the SLT_IDX values, starting with the lowest SQ_IDX value of the sequence index variable SQ_IDX.

The inner priority of the message 45 is therefore not determined by its position, or more precisely the position of the message 45, in the transmit priority queue TXPQ, but by the sequence index SQ_IDX.

In addition, there may be a jump back in the sequence index values (SQ_IDX values) of the message 45. The procedure for such SQ_IDX values is described below. In addition, the procedure described below with reference to FIG. 7 can be followed.

In order that the message management module 1122 can easily detect a jump back in the SLT_IDX values, the value range of SQ_IDX is divided into three directly consecutive ranges. The lower range B_A, starting with SQ_IDX-mn, and the upper range B_C, ending with SQ_IDX-mx, and between them the middle range B_B. All three ranges are at least #Slt−1 in size. They may also be larger.

This ensures that the numerical values of a sequence of SQ_IDX values that can be in the transmit priority queue TXPQ at the same time can never be in the three ranges B_A, B_B, B_C at the same time, but always only in two ranges. If the numerical values of a sequence of SQ_IDX values lie in both the range B_A and the range B_C, it can be reliably recognized that this sequence contains a jump back from SQ_IDX-mx, the end of range B_C, to SQ_IDX-mn, the beginning of range B_A. In all other cases, this sequence does not contain a jump back to SQ_IDX-mn. The minimum size for the ranges of #Slt−1 ensures that, in the case of a jump back, all upper elements of the sequence are in the range B_C and all lower elements of the sequence are in the range B_A.

In order to find the element or memory slot SLT_IDX (scan) in which the message 45 with the highest transmit priority is stored, the message management module 1122 compares the identifiers 4531, i.e., the priorities, of all elements of the queue TXPQ with the set TxRqst bit. The concept presented here makes it possible to perform these comparisons in a sequential procedure, in particular algorithm, or scan. This Tx_Scan procedure, in particular Tx_Scan algorithm, needs to be run only once to find the element with the highest transmit priority.

In particular, a scan through the elements or memory slots SLT_IDX of the queue TXPQ is not necessary if the TxRqst bit of an element or memory slot SLT_IDX that was not found to be the one with the highest transmit priority during the last Tx_Scan is canceled.

The sequence index SQ_IDX supplements the identifier 4531 during the internal arbitration in the subscriber station 10. The sequence index SQ_IDX is treated in a manner similar to decimal places of the integer CAN identifier.

The sequence index SQ_IDX can have as its value a number with a predetermined value range, in particular 0 to 255. However, other values or a different value range are possible for the sequence index SQ_IDX.

The communication control device 11, in particular the module 1121, manages one sequence index SQ_IDX per identifier 4531. The sequence index SQ_IDX is incremented for consecutive messages 45, i.e., increased by 1 (+1). When the maximum value is reached, the next increment causes a jump back to the minimum value SQ_IDX-mn.

For performing the method, the message management module 1122 can manage the five variables shown in FIG. 6.

The variable SLT_IDX, which is the sequential index of the elements of the queue TXPQ.

The variable RQST for a signal indicating that at least one element of the queue TXPQ with the set TxRqst bit was found. In the example of FIG. 6, a set TxRqst bit has the value 1.

The variable RES_IDX for a signal that indicates the index of the currently highest-priority element of the queue TXPQ.

The variable RES_ID for a signal that indicates the identifier 4531 of the element of the queue TXPQ to which the index RES_IDX points.

The variable RES_SQ for a signal that indicates the sequence index SQ_IDX of the element of the queue TXPQ to which the index RES_IDX points.

The message management module 1122 starts the Tx_Scan, or the sequence, with the first element of the queue TXPQ (SLT_IDX=0) and with RQST=0. The module 1122 sequentially reads the identifier 4531 and the sequence index SQ_IDX of the elements of the queue TXPQ to which the current sequence index SLT_IDX points, until the module 1122 comes to an element of the queue TXPQ whose transmit request is set (TxRqst=1).

Then, the message management module 1122, in particular the algorithm implemented by the module 1122, sets the following:

$$RQST = 1$$

$$RES\_IDX = SLT\_IDX$$

$$RES\_ID = Identifier ( SLT\_IDX )$$

$$RES\_SQ = SQ\_IDX ( SLT\_IDX )$$

Subsequently, the message management module 1122, in particular the algorithm implemented by the module 1122, continues and increments the variable SLT_IDX in each case until the module 1122 reaches the next element of the queue TXPQ whose transmit request is set (TxRqst=1). There, the module 1122 checks whether the variable RES_IDX has to be set to a new value. The module 1122 distinguishes the following three cases A), B) and C).

Case A): The variable RES_ID has a higher priority than the identifier 4531 in the currently checked element of the queue TXPQ (SLT_IDX). If this is the case, the variables RES_IDX, RES_ID and RES_SQ remain unchanged.

Case B): The variable RES_ID has a lower priority than the identifier 4531 in the currently checked element of the queue TXPQ (SLT_ID). If this is the case, the message management module 1122, in particular the algorithm implemented by the module 1122, sets the variables as follows:

$$RES\_IDX = SLT\_IDX$$

$$RES\_ID = Identifier ( SLT\_IDX ) = ID ( 4531 ) ( SLT\_IDX )$$

$$RES\_SQ = SQ\_IDX ( SLT\_IDX )$$

Case C): The variable RES_ID has the same priority as the identifier 4531 in the currently checked element of the queue TXPQ (SLT_IDX). If this is the case, the message management module 1122, in particular the algorithm implemented by the module 1122, checks the variables SQ_IDX(SLT_IDX) and RES_SQ.

Here, the two cases C1) and C2) are distinguished as follows.

For case C1), the message management module 1122, in particular the algorithm implemented by the module 1122, checks whether one of the two following conditions/alternatives linked by OR applies:
{[SQ_IDX(SLT_IDX) in range B_C] AND [RES_SQ in range B_A]}
OR
{[[SQ_IDX(SLT_IDX) NOT in range B_C] OR [RES_SQ NOT in range B_A]] AND [SQ_IDX(SLT_IDX)<RES_SQ]}

If the test in case C1) shows that one of the two conditions mentioned above is met, the message management module 1122, in particular the algorithm implemented by the module 1122, sets the following:

$$RES\_IDX = SLT\_IDX$$

$$RES\_ID = Identifier ( SLT\_IDX )$$

$$RES\_SQ = SQ\_IDX ( SLT\_IDX )$$

Otherwise, case C2) is present. That is to say, in the check of case C1), none of the conditions mentioned is met or true (ELSE). Then, the message management module 1122, in particular the algorithm implemented by the module 1122, leaves the variables RES_IDX, RES_ID and RES_SQ unchanged.

The message management module 1122, in particular the algorithm implemented by the module 1122, continues to perform the scan Tx_Scan until all elements of the queue TXPQ have been evaluated.

At the end of the procedure performed by the message management module 1122, RES_IDX points to the element or memory slot SLT_IDX or message 45 that is to be transmitted next if there is at least one element with a transmit request (RQST=1).

The following Table 1 shows an example of the transmit priority queue TXPQ for explaining the above-mentioned case C1). The following applies:

$$\# Slt = 6$$

The minimum number of SQ_IDX values is: 3*#Slt−1=3*6−1=17. However, in the example in Table 1 below, more than the minimum number of SQ_IDX values are used, namely 18 SQ_IDX values, as follows:
Range B_A: SQ_IDX has values from 0 . . . 5
Range B_B: SQ_IDX has values from 6 . . . 10
Range B_C: SQ_IDX has values from 11 . . . 17

TABLE 1
Identifier ID (4531) (decimal representation)

| SLT_IDX | TxRqst | ID (4531) | SQ_IDX | B_SQ_IDX |
|---|---|---|---|---|
| 0 | 1 | 100 | 0 | B_A |
| 1 | 1 | 100 | 1 | B_A |
| 2 | 1 | 200 | 0 | |
| 3 | 1 | 100 | 17 | B_C |
| 4 | 1 | 300 | 0 | |
| 5 | 1 | 400 | 0 | |

In the example of the transmit priority queue TXPQ in Table 1, the messages 45 with the identifier (ID) with the value 100 are transmitted in the following order: first, the message 45 in the memory slot SLT_IDX=3, then the message 45 in the memory slot SLT_IDX=0, and then the message 45 in the memory slot SLT_IDX=1. In this example, the sequence of values of the sequence index SQ_IDX for the messages 45 with the identifier (ID) 4531 with the value 100 contains a jump back from 17 to 0. The element from the upper subsequence (SLT_IDX=3) is therefore transmitted before the two elements from the lower subsequence (SLT_IDX=0, SLT_IDX=1).

The following Table 2 shows an example of the transmit priority queue TXPQ for explaining the above-mentioned case C2). The following applies:

$$\# Slt = 4$$

Number of SQ_IDX values: 3*#Slt−1=3*4−1=11
Range B_A: SQ_IDX has values from 0 . . . 3
Range B_B: SQ_IDX has values from 4 . . . 6
Range B_C: SQ_IDX has values from 7 . . . 10

TABLE 2
Identifier ID (4531) (decimal representation)

| SLT_ID | TxRqst | ID (4531) | SQ_IDX | B_SQ_IDX |
|---|---|---|---|---|
| 0 | 1 | 100 | 8 | B_C |
| 1 | 1 | 100 | 7 | B_C |
| 2 | 1 | 200 | 1 | |
| 3 | 1 | 100 | 6 | B_B |

In the example of the transmit priority queue TXPQ in Table 2, the messages 45 with the identifier (ID) with the value 100 are transmitted in the following order: first, the message 45 in the memory slot SLT_IDX=3, then the message 45 in the memory slot SLT_IDX=1, and then the message 45 in the memory slot SLT_IDX=0.

The method performed by the communication control device, in particular its modules 1121, 1122, and described above can always correctly detect the desired transmission order despite a jump back in the sequence index SQ_IDX. In order that the jump back in the sequence index SQ_IDX can be detected, the value range of the sequence index SQ_IDX has a certain minimum size, as described above, in particular 3×#Slt 1.

Due to the jump back in the sequence index SQ_IDX, all free memory slots SLT_IDX of the transmit priority queue TXPQ can always be used. No FIFO memory is required, as mentioned above.

According to a second exemplary embodiment, the predetermined value range of the sequence index SQ_IDX per identifier 4531 is not the same size. Accordingly, the predetermined value range of the sequence index SQ_IDX may be smaller for at least one identifier 4531 than for the other identifiers 4531. In addition, the predetermined value range of the sequence index SQ_IDX may be larger for at least one identifier 4531 than for the other identifiers 4531.

Otherwise, the second exemplary embodiment is designed as described above for the first exemplary embodiment.

According to a third exemplary embodiment, the predetermined value range of the three ranges B_A, B_B, B_C per sequence index SQ_IDX is the same size. As a result, the predetermined value range of the sequence index SQ_IDX is larger than in the first exemplary embodiment.

However, due to the three equally sized ranges B_A, B_B, B_C per sequence index SQ_IDX, the message management module 1122 can more easily ascertain in which range of the three ranges B_A, B_B, B_C an SQ_IDX value lies. For a particularly simple ascertaining of the message management module 1122, a value range for SQ_IDX from 0 to 3×#Slt−1 is recommended.

For such a case, applied to the above example in Table 1, where the three ranges B_A, B_B, B_C are defined, for 7 transmission slots, the formula 3*#Slt=3*7=21 applies, where #Slt is the number of transmission slots. Then, the following applies, with the three equally sized ranges:
Range B_A: SQ_IDX has values from 0 to 6
Range B_B: SQ_IDX has values from 7 to 13
Range B_C: SQ_IDX has values from 14 to 20.

For example, for the equally sized ranges B_A, B_B, B_C, the ranges B_A, B_B, B_C have the following sizes or values (here, SQ_IDX-mn=0):
Range B_A: Sizes or values from 0 to 1×#Slt−1
Range B_B: Sizes or values from 1×#Slt to 2×#Slt−1
Range B_C: Sizes or values from 2×#Slt to 3×#Slt−1

The advantage of such a selection of the three ranges B_A, B_B, B_C per sequence index SQ_IDX is that the arithmetic in hardware becomes somewhat simpler than in the example of Table 1 in the above-described exemplary embodiment.

FIG. 7 shows a table with rows Z1 to Z15 for the different possibilities available for assigning values for the sequence index SQ_IDX to messages 45 which have the same identifier (ID) 4531. According to rows Z11 to Z15, a jump back in the values of the sequence index SQ_IDX is possible. The assignment of sequence indices SQ_IDX shown in FIG. 7 and the resulting ranges B_A, B_B, B_C can realize the advantages described above.

In the example of FIG. 7, it is assumed that there are 6 memory slots in the transmit priority queue TXPQ, into which messages 45 with the same identifier (ID) 4531 are to be written one after the other. Each of the black squares in one of the rows Z1 to Z15 of the table of FIG. 7 represents a message 45 that is stored in one of the 6 memory slots in the transmit priority queue TXPQ. The table of FIG. 7 shows the values of the sequence index SQ_IDX which the transmission order determination module 1121 assigns to the corresponding message 45 before the message 45 is stored in the associated memory slot in the transmit priority queue TXPQ of FIG. 6.

Since the example of FIG. 7 assumes that the transmit priority queue TXPQ of FIG. 6 has a number of six elements or memory slots SLT_IDX, #Slt=6. As described above, the sequence index SQ_IDX in FIG. 7 therefore has fifteen values for the sequence index SQ_IDX, which has, for example, a value range from 0 to 14, as shown in FIG. 7. The minimum value SQ_IDX-mn of the transmit index SQ_IDX has the value 0 in the example of FIG. 7. The maximum value SQ_IDX-mx of the transmit index SQ_IDX has the value 14 in the example of FIG. 7. In general:

$$\# Slt = 6 \text{=>} Value range from SQ\_IDX \_min = 0 to SQ\_IDX \_max = 14 = 3 \times ( \# Slt - 1 ) - 1$$

Row Z1 of the table of FIG. 7 shows that, for the six consecutive messages 45, the transmission order determination module 1121 can, for example, assign or determine the values 9 to 14 for the sequence index SQ_IDX. The values 9 to 14 for the sequence index SQ_IDX are arranged in the ranges B_B and B_C. The messages 45 are then stored in the transmit priority queue TXPQ with their value for the sequence index SQ_IDX, optionally also with the value for the range index B_SQ_IDX, as described above with reference to FIG. 6. Storing the values for the range index B_SQ_IDX is not necessary since the message management module 1122 knows the sizes of the ranges B_A, B_B, B_C, for example by calculation from the number #Slt, and can therefore assign each SQ_IDX value to one of the ranges B_A, B_B, B_C. The message management module 1122 then evaluates that the messages 45 from row Z1 of the table of FIG. 7 are to be transmitted or are transmitted onto the bus 40 in the transmission order of sequence index SQ_IDX=9 to 14. Accordingly, the message 45 with transmit index SQ_IDX=9 is transmitted first onto the bus 40. Then the message 45 with transmit index SQ_IDX=10 is transmitted onto the bus 40. Then the message 45 with transmit index SQ_IDX=11 is transmitted onto the bus 40. Then the message 45 with transmit index SQ_IDX=12 is transmitted onto the bus 40. Then the message 45 with transmit index SQ_IDX=13 is transmitted onto the bus 40. Then the message 45 with transmit index SQ_IDX=14 is transmitted onto the bus 40.

According to the other possibilities/alternatives of rows Z2 to Z15 in FIG. 7, the same is true in FIG. 7 as described above in detail for the row Z1 of FIG. 7.

Possibility of row Z2: The transmission order determination module 1121 determines or assigns to the messages 45 the values 8 to 13 for the sequence index SQ_IDX, whereby the SQ_IDX values are arranged in the ranges B_B and B_C. As a result, the messages 45 are transmitted onto the bus 40 in the transmission order of sequence index SQ_IDX=8 to 13. Thus, message 45 with transmit index SQ_IDX=8 is transmitted onto the bus 40 before the other messages 45 in the row Z2, wherein, of these messages, the message 45 with transmit index SQ_IDX=13 is transmitted last.

Possibility of row Z3: The transmission order determination module 1121 determines or assigns to the messages 45 the values 7 to 12 for the sequence index SQ_IDX, whereby the SQ_IDX values are arranged in the ranges B_B and B_C. As a result, the messages 45 are transmitted onto the bus 40 in the transmission order of sequence index SQ_IDX=7 to 12, as described above correspondingly for row Z2.

Possibility of row Z4: The transmission order determination module 1121 determines or assigns to the messages 45 the values 6 to 11 for the sequence index SQ_IDX, whereby the SQ_IDX values are arranged in the ranges B_B and B_C. As a result, the messages 45 are transmitted onto the bus 40 in the transmission order of sequence index SQ_IDX=6 to 11, as described above correspondingly for row Z2.

Possibility of row Z5: The transmission order determination module 1121 determines or assigns to the messages 45 the values 5 to 10 for the sequence index SQ_IDX, whereby the SQ_IDX values are arranged in the ranges B_B and B_C. As a result, the messages 45 are transmitted onto the bus 40 in the transmission order of sequence index SQ_IDX=5 to 10, as described above correspondingly for row Z2.

Possibility of row Z6: The transmission order determination module 1121 determines or assigns to the messages 45 the values 4 to 9 for the sequence index SQ_IDX, whereby the SQ_IDX values are arranged in the ranges B_A and B_B. As a result, the messages 45 are transmitted onto the bus 40 in the transmission order of sequence index SQ_IDX=4 to 9, as described above correspondingly for row Z2.

Possibility of row Z7: The transmission order determination module 1121 determines or assigns to the messages 45 the values 3 to 8 for the sequence index SQ_IDX, whereby the SQ_IDX values are arranged in the ranges B_A and B_B. As a result, the messages 45 are transmitted onto the bus 40 in the transmission order of sequence index SQ_IDX=3 to 8, as described above correspondingly for row Z2.

Possibility of row Z8: The transmission order determination module 1121 determines or assigns to the messages 45 the values 2 to 7 for the sequence index SQ_IDX, whereby the SQ_IDX values are arranged in the ranges B_A and B_B. As a result, the messages 45 are transmitted onto the bus 40 in the transmission order of sequence index SQ_IDX=2 to 7, as described above correspondingly for row Z2.

Possibility of row Z9: The transmission order determination module 1121 determines or assigns to the messages 45 the values 1 to 6 for the sequence index SQ_IDX, whereby the SQ_IDX values are arranged in the ranges B_A and B_B. As a result, the messages 45 are transmitted onto the bus 40 in the transmission order of sequence index SQ_IDX=1 to 6, as described above correspondingly for row Z2.

Possibility of row Z10: The transmission order determination module 1121 determines or assigns to the messages 45 the values 0 to 5 for the sequence index SQ_IDX, whereby the SQ_IDX values are arranged in the ranges B_A and B_B. As a result, the messages 45 are transmitted onto the bus 40 in the transmission order of sequence index SQ_IDX=0 to 5, as described above correspondingly for row Z2.

Possibility of row Z11: The transmission order determination module 1121 uses a jump back in the values for the sequence index SQ_IDX. Thus, the transmission order determination module 1121 determines or assigns the value 14 for the sequence index SQ_IDX to the first message 45 and the values from 0 to 4 for the sequence index SQ_IDX to the subsequent messages 45, whereby the SQ_IDX values are arranged in the ranges B_A and B_C. As a result, the messages 45 are transmitted onto the bus 40 in the transmission order of sequence index SQ_IDX=14 and then 0 to 4, as described above correspondingly for row Z2.

Possibility of row Z12 with a jump back in the values for the sequence index SQ_IDX: Thus, the transmission order determination module 1121 determines or assigns the value 13 for the sequence index SQ_IDX to the first message 45 and the values 14 and then from 0 to 3 for the sequence index SQ_IDX to the subsequent messages 45, whereby the SQ_IDX values are arranged in the ranges B_A and B_C. As a result, the messages 45 are transmitted onto the bus 40 in the transmission order of sequence index SQ_IDX=13 and then 14 and then 0 to 3, as described above correspondingly for row Z2.

Possibility of row Z13 with a jump back in the values for the sequence index SQ_IDX: Thus, the transmission order determination module 1121 determines or assigns the value 12 for the sequence index SQ_IDX to the first message 45 and the values 13, 14, and then 0 to 2 for the sequence index SQ_IDX to the subsequent messages 45, whereby the SQ_IDX values are arranged in the ranges B_A and B_C. As a result, the messages 45 are transmitted onto the bus 40 in the transmission order of sequence index SQ_IDX=12 to 14 and then 0 to 2, as described above correspondingly for row Z2.

Possibility of row Z14 with a jump back in the values for the sequence index SQ_IDX: Thus, the transmission order determination module 1121 determines or assigns the value 11 for the sequence index SQ_IDX to the first message 45 and the values 12 to 14 and then 0 to 1 for the sequence index SQ_IDX to the subsequent messages 45, whereby the SQ_IDX values are arranged in the ranges B_A and B_C. As a result, the messages 45 are transmitted onto the bus 40 in the transmission order of sequence index SQ_IDX=11 to 14 and then 0 to 1, as described above correspondingly for row Z2.

Possibility of row Z15 with a jump back in the values for the sequence index SQ_IDX: Thus, the transmission order determination module 1121 determines or assigns the value 10 for the sequence index SQ_IDX to the first message 45 and the values 11 to 14 and then 0 for the sequence index SQ_IDX to the subsequent messages 45, whereby the SQ_IDX values are arranged in the ranges B_A and B_C. As a result, the messages 45 are transmitted onto the bus 40 in the transmission order of sequence index SQ_IDX=10 to 14 and then 0, as described above correspondingly for row Z2.

As shown in FIG. 7, when there is a jump back in the sequence of sequence index values (SQ_IDX values) of the message 45, the transmission order determination module 1121 divides the SQ_IDX values into two subsequences so that the SQ_IDX values are always located in only two ranges of the ranges B_A, B_B, B_C. The lower elements of the sequence have values from X up to the maximum value SQ_IDX-mx and the upper elements of the sequence have values from SQ_IDX-mn to Y. In the example of FIG. 7, which shows the minimum number of sequence index values (SQ_IDX values) for #Slt=6 memory slots, X=2 and Y=12 in row Z13, for example. The values X and Y are calculated such that both the upper subsequence and the lower subsequence have between one and #Slt−1 elements, i.e., a maximum of #Slt elements in total. Because the maximum value SQ_IDX-mx of SQ_IDX is significantly larger than the number #Slt of memory slots SLT_IDX, there is a large gap between the value of SQ_IDX(Y) and the value of SQ_IDX(X). In the example of FIG. 7, the difference between the value SQ_IDX(Y) and the value of SQ_IDX(X)=10. If there is a jump back, the upper subsequence is transmitted first, followed by the lower subsequence. Apart from the possible jump back, the messages 45 with the same identifier 4531 are transmitted in the relative order of their value for the sequence index SQ_IDX.

The message management module 1122 reliably detects a jump back in the SQ_IDX values if the sequence of SQ_IDX values located in the maximum #Slt transmission slots SLT_IDX of the queue TXPQ of FIG. 6 contains values both in the range B_A and in the range B_C. Then, the messages with an SQ_IDX value in the range B_C are transmitted first, followed by those with an SQ_IDX value in the range B_A. If the message management module 1122 does not detect a jump back, because there is no SQ_IDX value in the range B_A or no SQ_IDX value in the range B_C, the messages 45 are transmitted onto the bus 40 in the order of their SQ_IDX values.

Otherwise, the third exemplary embodiment is designed as described above for the first or second exemplary embodiment.

According to a fourth exemplary embodiment, all three ranges B_A, B_B, B_C are of different sizes.

Otherwise, the fourth exemplary embodiment is designed as described above for the first or second exemplary embodiment.

In general, for all exemplary embodiments, the ranges B_A, B_B, B_C have at least the following sizes or values (here, SQ_IDX-mn=0):
Range B_A: Sizes or values from 0 to 1×#Slt−2
Range B_B: Sizes or values from 1×#Slt−1 to 2×#Slt−3
Range B_C: Sizes or values from 2×#Slt−2 to 3×#Slt−4

At this minimum size, the ranges B_A, B_B, B_C are the same size. If the minimum size is selected, the message management module 1122 must manage fewer values for the sequence index SQ_IDX and thus for the ranges B_A, B_B, B_C. Of course, larger values for the sequence index SQ_IDX and thus the ranges B_A, B_B, B_C can be selected.

All of the above-described embodiments of the communication control device 11, the modules 1121, 1122, 1123 and their modifications, the subscriber stations 10, 30, the bus system 1 and the method carried out therein may be used individually or in all possible combinations. In particular, all features of the above-described exemplary embodiments and/or their modifications can be combined as desired. Additionally or alternatively, the following modifications are possible in particular.

Although the present invention is described above using the example of the CAN bus system, the present invention can be used in any communication network and/or communication method in which an internal transmission order of messages in a transmission queue is to be determined in a communication control device.

Although the present invention is described above using the example of the CAN bus system, the present invention can be used in any communication network and/or communication method in which two different communication phases are used in which the bus states generated for the different communication phases are different.

In particular, the bus system 1 according to the exemplary embodiments can be a communication network in which data can be transmitted serially at two different bit rates. It is advantageous, but not necessarily a prerequisite, for an exclusive, collision-free access of a subscriber station 10, 20, 30 to a common channel to be ensured for the bus system 1, at least for certain time periods.

In the exemplary embodiments, the number and arrangement of the subscriber stations 10, 20, 30 in the bus system 1 is arbitrary. In particular, the subscriber station 20 in the bus system 1 can be omitted. It is possible for one or more of the subscriber stations 10 or 30 to be present in the bus system 1. It is possible for all subscriber stations in the bus system 1 to be designed identically, i.e., only subscriber stations 10 or only subscriber stations 20 or only subscriber stations 30 are present.

What is claimed is:

1. A communication control device for a subscriber station for a serial bus system, comprising:
a message management module configured to manage messages to be transmitted by the communication control device onto a bus of the bus system for controlling communication of the subscriber station with at least one other subscriber station of the bus system; and
a transmission order determination module configured to determine a sequence index for the messages;
wherein each message of the messages has an identifier whose value indicates a priority with which the message is to be transmitted onto the bus;
wherein the transmission order determination module is configured to determine a sequence index for each of the identifiers and to assign the determined sequence index to the identifier; and
wherein the message management module is configured to ascertain a transmission order for those of the messages whose identifiers have the same value, using the sequence index.

2. The communication control device according to claim 1, wherein:
the transmission order determination module is configured to assign the determined sequence index in a message storage module to the identifier and
the message management module is configured to ascertain the transmission order for those of the messages whose identifiers have the same value, using the sequence index stored in the message storage module.

3. The communication control device according to claim 2, wherein the message storage module has a transmit priority queue having a predetermined number of memory slots in which a message with the identifier and the sequence index is stored.

4. The communication control device according to claim 2, wherein:
the message storage module has a transmit priority queue having a predetermined number of memory slots in which a message with the identifier, the sequence index, and a range is stored,
the sequence index has a predetermined value range, and
the range is one of three ranges into which the predetermined value range of the sequence index is divided.

5. The communication control device according to claim 4, wherein:
the sequence index is an integer selected from the predetermined value range, and
the transmission order determination module is configured to increment the sequence index for each consecutive message in the transmit priority queue and, after exceeding a maximum value of the predetermined value range of the sequence index, to jump back to a minimum value of the value range for a next message in the transmit priority queue.

6. The communication control device according to claim 5, wherein the predetermined value range of the sequence index is determined in that there is a difference of at least 3×#Slt−4 between the minimum value of the sequence index and the maximum value of the sequence index, where #Slt is the predetermined number of memory slots in the transmit priority queue.

7. The communication control device according to claim 4, wherein:
the predetermined value range of the sequence index is divided into three directly consecutive ranges which have a first range, a second range, and a third range, and each of the directly consecutive ranges has a minimum size of #Slt−1, where #Slt is the predetermined number of memory slots in the transmit priority queue,
the first range starts with the minimum value of the sequence index,
the second range is arranged in a seamless and non-overlapping manner between the first range and the third range, and
the third range ends with the maximum value of the sequence index.

8. A subscriber station for a serial bus system, comprising:
a communication control device, including:
a message management module configured to manage messages to be transmitted by the communication control device onto a bus of the bus system for controlling communication of the subscriber station with at least one other subscriber station of the bus system, and
a transmission order determination module configured to determine a sequence index for the messages,
wherein each message of the messages has an identifier whose value indicates a priority with which the message is to be transmitted onto the bus,
wherein the transmission order determination module is configured to determine a sequence index for each of the identifiers and to assign the determined sequence index to the identifier, and
wherein the message management module is configured to ascertain a transmission order for those of the messages whose identifiers have the same value, using the sequence index; and
a transmitting/receiving device configured to transmit a signal generated by the communication control device for a frame, onto a bus of the bus system and to receive a signal from the bus;
wherein the communication control device is configured to, in a first communication phase, to negotiate with other subscriber stations on the bus as to which of the subscriber stations of the bus system will at least temporarily receive exclusive, collision-free access to the bus in a subsequent second communication phase.

9. The subscriber station according to claim 8, wherein the transmitting/receiving device is configured to generate bus states for the frame with a first operating mode in the first communication phase and to generate bus states for the frame with a second operating mode that differs from the first operating mode, in the second communication phase.

10. A bus system, comprising:
a bus; and
at least two subscriber stations which are connected to one another via the bus in such a way that they can communicate with one another serially and of which at least one subscriber station is a subscriber station including:
a communication control device, including:
a message management module configured to manage messages to be transmitted by the communication control device onto a bus of the bus system for controlling communication of the subscriber station with at least one other subscriber station of the bus system, and
a transmission order determination module configured to determine a sequence index for the messages,
wherein each message of the messages has an identifier whose value indicates a priority with which the message is to be transmitted onto the bus,
wherein the transmission order determination module is configured to determine a sequence index for each of the identifiers and to assign the determined sequence index to the identifier, and
wherein the message management module is configured to ascertain a transmission order for those of the messages whose identifiers have the same value, using the sequence index; and
a transmitting/receiving device configured to transmit a signal generated by the communication control device for a frame, onto a bus of the bus system and to receive a signal from the bus;
wherein the communication control device is configured to, in a first communication phase, to negotiate with other subscriber stations on the bus as to which of the subscriber stations of the bus system will at least temporarily receive exclusive, collision-free access to the bus in a subsequent second communication phase.

11. A method for handling messages in a subscriber station of a serial bus system, wherein the method is carried out with a communication control device of the subscriber station), and wherein the communication control device carries out the following steps comprising:
managing, using a message management module, messages to be transmitted by the communication control device (11;
onto a bus of the bus system for controlling communication of the subscriber station with at least one other subscriber station of the bus system; and
determining, using a transmission order determination module, a sequence index for the messages;
wherein each message of the messages has an identifier whose value indicates a priority with which the message is to be transmitted onto the bus;
wherein the transmission order determination module, in the step of determining, determines a sequence index for each of the identifiers and assigns the determined sequence index to the identifier; and
wherein the message management module, in the step of managing, ascertains the transmission order for those of the messages whose identifiers have the same value, using the sequence index.
